(19) United States
(12) Patent Application Publication
(10) Pub. No.: US 2014/0129244 A1
(43) Pub. Date: May 8, 2014

(54) MODIFYING TIME DATA VALUES BASED ON SEGMENT RULES

(71) Applicant: Management Insight Analytics, Inc., (US)

(72) Inventors: Thomas Paul Joseph, Ann Arbor, MI (US); Denis Robert Burke, Canton, MI (US)

(73) Assignee: Management Insight Analytics, Inc., Ann Arbor, MI (US)

(21) Appl. No.: 13/797,563

(22) Filed: Mar. 12, 2013

Related U.S. Application Data
(60) Provisional application No. 61/721,900, filed on Nov. 2, 2012.

(51) Int. Cl. G06Q 10/06; G06Q 50/22

(52) U.S. Cl. CPC G06Q 10/06393; G06Q 50/22
USPC 705/2

(57) ABSTRACT

In an embodiment, a method comprises: creating and storing laboratory test turnaround time (TAT) measurement data comprising one or more TAT values for one or more time segments associated with one or more laboratory sample processing stages in a testing laboratory; wherein, for a particular laboratory sample processing stage, a particular TAT value, from the one or more TAT values, is associated with a particular time segment, from the one or more time segments; applying one or more segment specific rules to the particular TAT value associated with the particular time segment to determine whether the particular TAT value is invalid; in response to determining that the particular TAT value is invalid, modifying the TAT measurement data for the particular time segment for the particular stage by removing the particular TAT value; repeating the applying and the modifying for all the TAT measurement data.

### PRIORITY CLAIM

This application claims domestic priority under 35 U.S.C. 119(e) from prior provisional application Ser. No. 61/721,900 filed Nov. 2, 2012, of Thomas P. Joseph, et al., titled “Modifying Time Data Values Based on Segment Rules,” attorney docket number 60220-0019, the entire content of which is hereby incorporated by reference as if fully set forth herein.

### TECHNICAL FIELD

The present disclosure is generally related to data benchmarking, and more specifically, to computer assisted performance monitoring of service indicators in healthcare industry services.

### BACKGROUND

One of the objectives in service monitoring is to measure the quality of provided services. The monitoring may be especially important in measuring the service performance of healthcare facilities such as emergency departments, urgent care departments and medical laboratories. The monitoring may provide indications of efficiency and productivity of the healthcare facility and permit management analysis or evaluation of changes.

Generating performance data may include collecting test results and associated timestamps, and computing turnaround time data from the timestamps. While the test results are generally reliable, the timestamps and turnaround time data may be unreliable for the purpose of data benchmarking.

Reasons for timestamp data inaccuracies may vary. Some timestamps may be incorrectly typed into a computer system or not entered at all. Other timestamps may be entered correctly but the order of the events associated with the timestamps may be unusual. For example, in the context of treatment in a hospital emergency department, a particular test may be collected before an order for the test is entered into the system. Hence, a specimen may be collected minutes or even hours before the test order is actually logged into the system. For the purpose of data benchmarking, relying on the timestamps in such a situation may be confusing.

These and other problems with timestamps may negatively impact benchmarking of the information derived from the timestamps. For example, the problems with timestamps may cause generating unusual values for turnaround times, skew the benchmarking results, and ultimately, provide inaccurate ratings for the benchmarked facility.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

The appended claims may serve as a summary of the invention.

### BRIEF DESCRIPTION OF THE DRAWINGS

In the drawings:

FIG. 1 illustrates an embodiment of a system configured to modify time data values using segment rules;

FIG. 2 illustrates an embodiment of time segments;

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, FIG. 3M, FIG. 3N illustrate various embodiments of segment rules for modifying time data values;

FIG. 4 illustrates an embodiment of a process flow for modifying time data values based on segment rules;

FIG. 5 illustrates an example computer system with which an embodiment may be implemented.

### DESCRIPTION OF EXAMPLE EMBODIMENTS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 Overview
2.0 Structural and Functional Overview
3.0 Time Segments
4.0 Segment Specific Rules
5.0 Modifying Time Data Values Based on Segment Specific Rules
6.0 Implementation Mechanisms—Hardware Overview
7.0 Extensions and Alternatives

1.0 Overview

The various embodiments of the present invention address the above-described challenges with important improvements over the prior art in terms of speed, flexibility, and presentation of the turnaround time performance data. In accordance with example embodiments of the present disclosure, performance reporting is made accessible to management, including managers in a variety of medical disciplines such as laboratory and emergency departments, and emergency response services.

Although the examples described below refer to medical applications, the described approach may be implemented in any type of testing, not necessarily medical. For example, the described approach may be implemented in product quality testing and customer service testing.

A method, a system and a computer program in accordance with one embodiment provide an approach for eliminating invalid turnaround time data using time segment-specific rules.

In an embodiment, a method comprises creating and storing turnaround time (TAT) measurement data comprising one or more TAT values for one or more time segments associated with one or more laboratory sample processing stages in a testing laboratory.

For a particular laboratory sample processing stage, a particular TAT value, from the one or more TAT values, is associated with a particular time segment and a particular stage, from the one or more time segments.

In an embodiment, a method further comprises applying one or more time segment specific rules to the particular TAT value associated with the particular time segment to determine whether the particular TAT value is invalid.

In response to determining that the particular TAT value is invalid, the TAT measurement data for the particular time segment for the particular stage are modified by removing the particular TAT value from the TAT measurement data.

In an embodiment, a method further comprises repeating the applying and the modifying for all the TAT measurement data.

In an embodiment, a method is performed by one or more computing devices.

In an embodiment, a method further comprises determining a type of the particular time segment and storing the type in association with the particular time segment. The type may be any one of: an admit-to-order, an order-to-collect, a collect-to-order, a collect-to-receive, a receive-to-perform, a perform-to-verify, an admit-to-receive, a receive-to-bench, a bench-to-verify, an order-to-receive, a receive-to-verify, a collect-to-verify, an order-to-verify, and an admit-to-verify.

In response to determining that a type of the particular time segment is the admit-to-order, the collect-to-receive, the receive-to-bench, the receive-to-perform, the admit-to-receive, the order-to-receive, or the collect-to-order, the particular TAT value may be removed from the TAT measurement data in response to determining that the particular TAT value is non-positive.

In response to determining that the type of the particular time segment is the order-to-collect, the particular TAT value may be removed from the TAT measurement data in response to determining that the particular TAT value is non-positive and not associated with an emergency department testing.

In response to determining that the type of the particular time segment is the bench-to-verify, receive-to-verify, admit-to-verify, order to verify, or collect-to-verify, the particular TAT value may be removed from the TAT measurement data in response to determining that the particular TAT value is non-positive or that the particular TAT value is positive but does not exceed a threshold value.

In response to determining that the type of the particular time segment is the perform-to-verify, the particular TAT value may be removed from the TAT measurement data in response to determining that the particular TAT value is negative. TATs with a value of zero are associated with an auto-validation and are valid.

In response to determining that the type of the particular time segment is the receive-to-verify, the particular TAT value may be removed from the TAT measurement data in response to determining that the particular TAT value is non-positive or that the particular TAT value is positive but does not exceed the threshold value.

In an embodiment, based, at least in part, on the TAT measurement data, one or more outlier graphical screen displays is generated in a computer display unit that represent the particular laboratory sample processing stage occurring within one or more time intervals, and that depict the one or more time segments, each particular TAT time for each particular time segment from the one or more time segments, each particular TAT time that has not been removed, a TAT outlier baseline and a target TAT.

In an embodiment, maintaining the TAT measurements report comprises: receiving laboratory performance data comprising timestamps and a plurality of performance data attributes for events of interest; based, at least in part, on the timestamps and the performance data attributes, determining the one or more time segments for the particular event of interest and storing the one or more time segments in the TAT measurement data; based at least in part on the performance data attributes, generating, for the particular time segment from the one or more time segments, the particular TAT value, and storing the particular TAT value in association with the particular time segment in the TAT measurement data.

The foregoing and other features and aspects of the disclosure will become more readily apparent from the following detailed description of various embodiments.

2.0 Structural and Functional Overview

In an embodiment, a system is provided for modifying time data values using one or more time segment specific rules. Examples of time data values may include timestamps and associated data such as TAT values generated from the timestamp values. The timestamps and associated data may be entered from processing stations and communicated from the stations to a management processor via a network. The management processor may be configured to process the timestamps and associated data, apply the segment rules to the processed data, generate modified data, and generate performance reports from the modified data.

The system described herein may be implemented in any type of a healthcare facility, such as a medical laboratory, a clinic, a hospital, or a physician office. Furthermore, the system described herein may be implemented in any type of a customer service facility or a service provider facility.

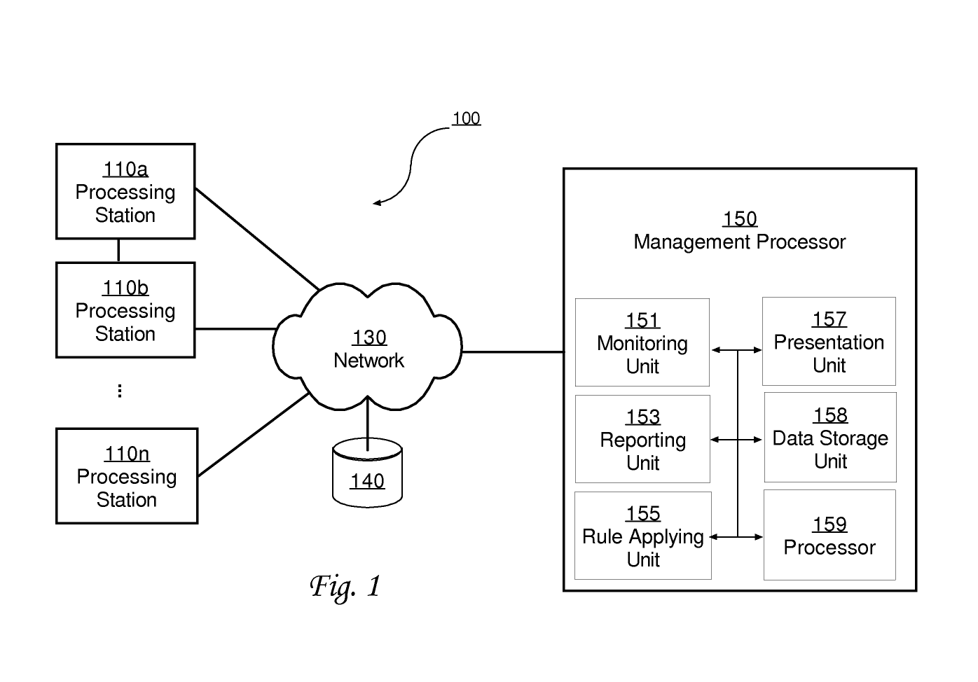

FIG. 1 illustrates an embodiment of a system configured to modify time data values using segment specific rules. A computer system 100 comprises one or more processing stations 110a . . . 110n, one or more networks 130, one or more system databases 140, and one or more management processors 150.

In an embodiment, processing stations 110a . . . 110n represent any number of computerized stations for performing various tasks and entering timestamps indicating the times when the respective tasks were performed. In a healthcare application, the tasks may correspond to laboratory processing stages, and may include ordering a laboratory test for a patient, collecting a specimen for the test, performing the test on the collected specimen, verifying the accuracy of test results.

In healthcare related implementations, for the purpose of data benchmarking, processing stations 110a . . . 110n may represent test ordering stations, specimen collection stations, specimen receiving stations, laboratory testing benches and testing equipment, emergency department test ordering stations, laboratory test performing stations and test result verification stations.

Processing stations 110a . . . 110n may include computer devices located in medical clinics, medical offices, medical laboratories, hospitals, and other health related facilities. For example, a processing station may be a computer that is located at a nurse station and that is used to enter test orders into database 140. According to another example, a processing station may be a computer located in a medical laboratory from which test results may be entered into a database 140. Other examples of processing stations may include a computer installed in an emergency department for entering information about tests performed in the emergency department.

In an embodiment, processing stations 110a . . . 110n may by any type of computing devices such as workstations, laptops, PDA devices, smartphones, tablet devices or any other computer devices configured to receive, process and transmit data.

For the purpose of illustrating clear examples, FIG. 1 shows three (3) processing devices 110a, 110b and 110n, but other embodiments may use any number of processing devices. For example, a processing station 110a may correspond to a nurse computer at a medical clinic, a processing station 110b may correspond to a specimen collection station at a medical laboratory, and a processing station 110n may correspond to a testing bench at an analysis center where the test on the specimen may be performed. However, practical embodiments may use any number of processing stations 110a . . . 110n.

For the purpose of illustrating clear examples, processing stations 110a . . . 110n are depicted as separate stations communicatively coupled to network 130. However, in practical embodiments, one or more processing stations may communicate with each other directly, and/or may be combined and represented as one processing station. For example, a test ordering station may also be configured as a specimen collection station. Such a station configuration may occur when a test order and specimen collection timestamp are entered into database 140 from the same computer. In such circumstances, the functionalities of any two or more processing stations of 110a . . . 110n may be combined into one processing station.

Database 140 may be any type of a device configured to receive, store and transmit data. Examples of such devices include a simple database system, a distributed storage system, a relational database storage system, or any other data storage device known in the industry.

Data entered into database 140 may be entered in a variety of ways, including manual entry, automatic entry or a combination of thereof. For example, the data may be manually entered by a staff employee who types the information on a keyboard of a processing station. The data may be also entered by scanning a bar code or a quick response (QR) code image using a scanner, and transmitting the scanned data to database 140. The data may also be provided by a computer application executed on any of processing stations 110a . . . 110n.

Data entered into database 140 may be represented in a variety of data structures. For example, the data may be stored in database 140 in spreadsheets, tables, comma separated value format data, or any other structures.

Data in database 140 may be organized by the name of the patient, by the type of the test to be performed, by the name of the laboratory processing stage, by the name of the laboratory testing station, by the entity ordering the test, or any other data organization scheme.

Network 130 facilitates communications between processing stations 110a . . . 110n, database 140 and management processor 150. For example, network 130 may be configured to receive information from processing stations 110a . . . 110n, store the received information in database 140, transmit the information from database 140 to processing stations 110a . . . 110n and to management processor 150 and receive the information from management processor 150. Hence, upon ordering a particular test from a particular processing station 110a, the order information may be transmitted via network 130 to database 140, and the data stored in database 140 may be transmitted from database 140 via network 130 to management processor 150.

Management processor 150 may be configured to request, receive, process and analyze data received from processing stations 110a . . . 110n and database 140. Management processor 150 may receive the data directly and/or indirectly from processing stations 110a . . . 110n. Furthermore, management processor 150 may receive the data directly and/or indirectly from network 130. Alternatively, management processor 150 may receive some data from the processing stations and some data from database 140.

Configurations of management processor 150 may vary between implementations, and the types and quantity of components implemented within management processor 150 may depend on the type of the facility or testing laboratory.

In an embodiment, management processor 150 comprises one or more monitoring units 151, one or more reporting units 153, one or more rule applying units 155, one or more presentation units 157, one or more data storage units 158 and one or more processors 159. In other embodiments, the functionalities of the units may be combined and/or the quantity of units may be reduced. For example, as depicted in FIG. 1, management processor 150 may comprise one monitoring unit 151, one reporting unit 153, one rule applying unit 155, one presentation unit 157, one data storage unit 158 and one processor 159.

Monitoring unit 151 may be configured to request and receive test measurement data from processing stations 110a . . . 110n, network 130 and/or system database 140. Monitoring unit 151 may also be configured to store the received test measurement data in data storage 158, and determine a time schedule for processing the received test measurement data. For example, monitoring unit 151 may determine a specific data/time when the received test measurement data should be processed, or a specific time frequency with which the received test measurement data should be processed. Monitoring unit 151 may also determine one or more subsets of the test measurement data that need to be processed at a particular date/time, or one or more sets of events that may trigger processing of a particular set of the received test measurement data.

Reporting unit 153 may be configured to retrieve data from data storage unit 158, and generate a data report from the retrieved data. A report may provide benchmarked data depicting efficiency indicators specific to the tested facility. In an embodiment, reporting unit 153 may collaborate with monitoring unit 151 for determining one or more particular set of measurement data and determining the timing for the data processing. Reporting unit 153 may also collaborate with a rule applying unit 155 for determining one or more sets of rules for modifying the measurement data.

Rule applying unit 155 may be configured to create, store and provide segment specific rules for processing measurement data. For example, rule applying unit 155 may be configured to create one or more sets of segment rules to be applied to the measurement data, store the sets in data storage unit 158, retrieve the sets from the data storage unit 158 and apply the retrieved rules to a particular set of measurement data.

In an embodiment, rule applying unit 155 is configured to determine whether time related measurement data is inaccurate in some aspect. The inaccuracies may be caused by human errors, data transmission errors or any other type errors. For example, it is possible that a timestamp for collecting a particular specimen for a particular test was mistyped. This and other errors in the test measurement data may be eliminated by application of the segment specific rules, as it will be described in detail below.

Presentation unit 157 may be configured to provide one or more data performance reports to management. The reports may provide benchmarked data depicting efficiency indicators specific to the tested facility. The reports may be presented in a form of one or more spreadsheets, one or more charts and/or one or more outliers. Furthermore, the reports may be printed as hardcopies or displayed on displays of computing devices. The reports may be graphically represented in a graphical user interface, a graphical dashboard, one or more computer-navigated charts, one or more interactive outliners, or any other computer generated graphical depictions.

Data storage 158 may be configured to store a variety of data, including test measurement data, time segments, segment rules, data reports, processing instructions, patient records, laboratory technician records, and other data related to test processing. Data storage 158 may be implemented in one or more storage devices communicatively coupled with each other and managed locally or globally.

Processor 159 executes commands and instructions specific to management processor 150. For example, processor 159 may facilitate communications to and from management processor 150, process commands received by and executed by management processor 150, process responses received by management processor 150, and facilitate various types of operations executed by management processor 150. Processor 159 may comprise hardware and software logic configured to execute various processes on management processor 150.

Processing stations 110a . . . 110n, network 130, database 140 and management processor 150 may implement the processes described herein using hardware logic such as in an application-specific integrated circuit (ASIC), field-programmable gate array (FPGA), system-on-a-chip (SoC) or other combinations of hardware, firmware and/or software.

3.0 Time Segments

A time segment may represent a time period between two events. In particular, a time segment may be defined as a time period elapsing from a beginning time value to an end time value. A time segment may have associated a beginning timestamp and an end timestamp.

Although time segment examples described below refer to medical applications, similar examples may be defined and implemented in any type of testing, not necessarily medical. For example, time segments may be defined and implemented in product quality testing, goods testing, food products testing and customer services testing.

In the context of a laboratory turnaround time performance monitoring, a time period from ordering a particular test to completing the particular test may be divided into a set of time segments. The methodology for identifying the time segments may depend on the implementation of the monitoring system and on the objectives of the performance benchmarking. In some implementations, the time segments may be sequentially ordered; in some other implementations, the time segments may overlap. In yet other implementations, the segments may be partially ordered and partially overlapping.

In health-related applications, time segments may be test specific. In an embodiment, for a particular test, various events (or laboratory processing stages) associated with the particular test may be identified and used to delineate one or more time segments. For example, one time segment may be identified as the time periods elapsing from ordering a medical test to collecting a specimen for the test. Another time segment may be identified as the time period elapsing from collecting the specimen for the test to performing the test. Another time segment may be identified as the time period elapsing from performing the test to verifying the test results.

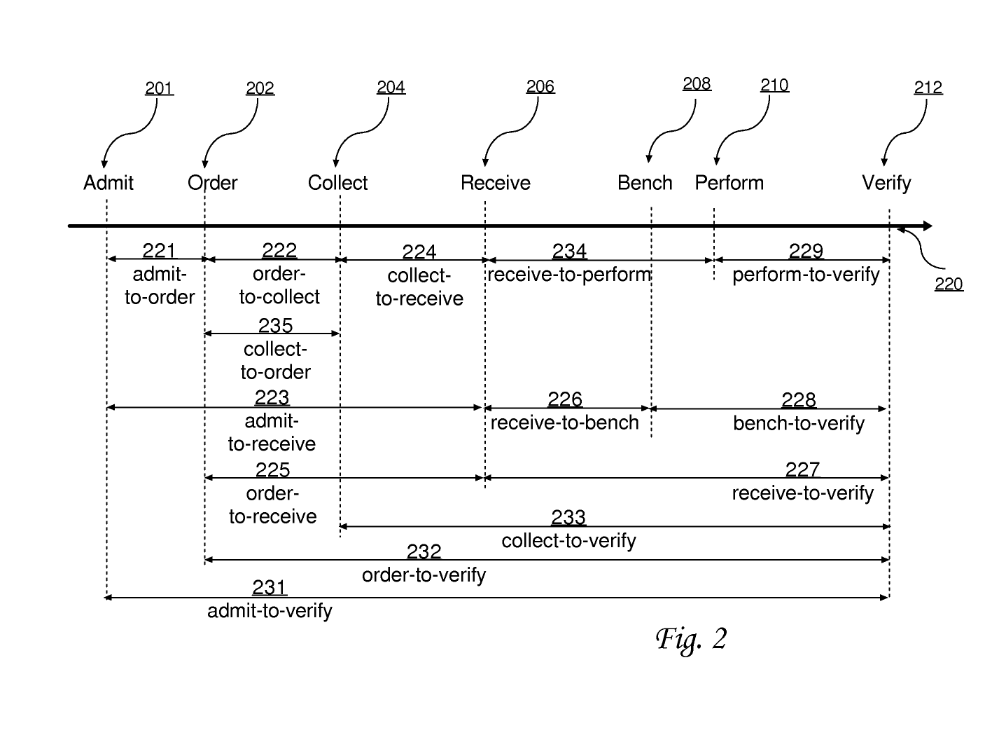

FIG. 2 illustrates an embodiment of time segments. In the example depicted in FIG. 2, several events have been identified along a time axis 220, and various time segments have been defined as delineated by the events. Examples of the events or stages may include an order time 202, a collect time 204, a receive time 206, a bench time 208, a perform time 210 and a verify time 212. While the description of the time events depicted in FIG. 2 is provided in the context of medical application, other embodiments may be used with other types of applications, such as customer services benchmarking.

An order time 202 may indicate a point in time when an order of a particular test to be performed for a patient was entered into a system database. More specifically, order time 202 is the time entered by a medical staff into the database as the time when the particular test was ordered. The clarification emphasizes the fact that order time 202 is not necessarily the exact time when the order was placed; instead, it is the time that was entered to the database as the correct order time 202. For example, after a physician requested that a particular test be performed for a patient, an assisting nurse may enter the order into the system database. However, the nurse's entry may not be the correct time of the test order. For example, the nurse might have made a typographical mistake while entering the time to the database.

Order time 202 may be entered into database 140 from any of processing stations 110a . . . 110n, described in FIG. 1. Ordering a test may comprise ordering any one of a blood work, an X-ray, a urinalysis, a fecal occult test, a colonoscopy, a mammogram and any other medical test.

A collect time 204 may indicate the time when a specimen was collected from a patient. In particular, collect time 204 is the time entered by medical or laboratory staff into a system database as the time when the particular specimen was collected from the patient. Hence, collect time 204 may or may not coincide with the actual time indicating the time when the specimen was collected.

Collecting a specimen may comprise any one of drawing a patient blood, taking a chest X-ray, measuring a blood pressure, and collecting any other tissue or body fluid from the patient. Collection of a specimen may be performed at a nurse station, at a medical clinic, at a medical laboratory or at any other station.

Collect time 204 may be entered into database 140 from any of processing stations 110a . . . 110n, depicted in FIG. 1.

A receive time 206 may indicate the time when a specimen was received at a testing laboratory. More specifically, receive time 206 is the time entered by a laboratory technician as the time when the particular specimen was received at the laboratory. Thus, receive time 206 may or may not correspond to the actual time when the specimen was received.

Receive time 206 may indicate the time when a blood sample, an X-ray image, or any other specimen data was received at a medical laboratory or any other testing station. The laboratory receiving station may be any of processing stations 110a . . . 110n, depicted in FIG. 1.

A bench time 208 may indicate the time when a specimen was received at a testing laboratory bench. More precisely, bench time 208 is the time entered or scanned in by a laboratory technician into a system database as the time when the particular specimen was placed, or otherwise received, at the testing laboratory bench. Hence, bench time 208 may be the accurate time or may be entered in error.

The term bench may refer to a physical desk, a physical testing device, an office, a receiving counter, or any other object involved in testing the specimen. For example, a bench may correspond to a desk at which the test may be performed, or any other destination at which the test may be performed. For example, a bench may be understood as a desk at which a blood analyzer is installed. The bench may be represented as any one of processing stations 110a . . . 110n.

Bench time 208 may indicate the time when a blood sample was delivered to a blood analyzer in a laboratory, the time when an X-ray image was placed in an image reader, or the time when any other patient related data was delivered to a technician for testing.

A perform time 210 may indicate the time when a technician or laboratory analyzer completed performing the ordered test. More specifically, perform time 210 is the time entered by a laboratory technician into a system database as the time when performing of the ordered test was completed. Perform time 210 may correspond to the exact time when the test was completed, or the entry may be made in error.

Perform time 210 may indicate the time when a blood work for a particular patient was completed and results have been entered into a computer system, when a radiologist finished examining an X-ray image and entered his diagnosis to the system, or when performing of some other test was completed. A station at which the test was performed may be any of processing stations 110a . . . 110n.

A verify time 212 may indicate the time when the results of a particular test have been verified and results made available to the medical staff. In particular, verify time 212 is the time entered by a laboratory technician into a database as the time when the results of the particular test were verified. Hence the entered verify time 212 may not be the exact or correct time of the test verification.

Result verification may be performed automatically after a primary testing is completed to assure a high accuracy of the results. For example, a drug test or an HIV test may be repeated automatically to gain confidence that the test results are correct. A result verification may also be performed on a case-by-case basis, especially when the results seem to be unexpected or significantly exceeding the expected thresholds. In both cases, the time indicating the time when the test results are verified may be entered manually or automatically. A station from which verify time 212 is entered may be referred to as any of processing stations 110 . . . 110n.

FIG. 2 also depicts examples of time segments. The examples include the segments labeled as an admit-to-order segment 221, an order-to-collect segment 222, a collect-to-order segment 235, a collect-to-receive segment 224, a receive-to-perform segment 234, a perform-to-verify segment 229, an admit-to-receive 223 segment, a receive-to-bench segment 226, a bench-to-verify segment 228, an order-to-receive 225, a receive-to-verify segment 227, a collect-to-verify segment 233, an order-to-verify segment 232, and an admit-to-verify segment 231. The time segments depicted in FIG. 2 merely illustrate examples of time segments and are specific to medical applications. However, depending on the implementation, other types and names of time segments may be identified.

The admit-to-order segment 221 may represent a time period elapsing from admit time 201 to order time 202. For example, admit-to-order segment 221 may represent the time that elapsed from the moment a patient was admitted to a medical facility to the moment a nurse entered the test order information into a computer system.

The admit-to-order segment 221 may be computed from admit time 201 and order time 202 as a difference between order time 202 and admit time 201. Alternatively, admit-to-order segment 201 may be manually entered or otherwise derived.

The order-to-collect segment 222 may represent a time period elapsing from order time 202 to collect time 204. For example, order-to-collect segment 222 may represent the time that elapsed from the moment a nurse entered the test order information into a computer system to the moment the respective specimen for the particular test was collected from a patient at a medical laboratory. Examples of collecting a specimen may include drawing a blood from a patient at the medical laboratory, or taking an X-ray of the patient's chest.

The order-to-collect segment 222 may be computed from order time 202 and collect time 204 as a difference between collect time 204 and order time 202. Alternatively, order-to-collect segment 222 may be manually entered or otherwise derived.

The collect-to-order segment 235 may represent a time period elapsing from collect time 204 to order time 202. While the convention is that an order to collect a specimen from a patient is usually placed first, and the specimen is collected next, in some emergency situations, the specimen is collected and sent to a lab as soon as the patient arrives, and the order to collect the specimen is placed by the medical staff after the specimen is collected. This shortens the TAT times.

The collect-to-order segment 235 may be computed from collect time 204 and order time 202 as a difference between order time 202 and collect time 204. Alternatively, collect-to-order segment 235 may be manually entered or otherwise derived.

The collect-to-receive segment 224 may represent a time period elapsing from collect time 204 and receive time 206. For example, collect-to-receive time segment 224 may represent the time that elapsed from the moment a specimen for a particular test was collected from a patient to the moment the specimen for the particular test was received at a medical laboratory.

The collect-to-receive segment 224 may be computed from collect time 204 and receive time 206 as a difference between receive time 206 and collect time 204. Alternatively, collect-to-receive segment 224 may be entered manually or otherwise derived.

The receive-to-perform segment 234 may represent a time period elapsing from perform time 210 and receive time 206. For example, receive-to-perform segment 234 may represent the time that elapsed from the moment a specimen was received at a medical laboratory to the moment a particular test of the specimen was performed.

The receive-to-perform segment 234 may be computed from receive time 206 and perform time 210 as a difference between perform time 210 and receive time 206. Alternatively, receive-to-perform segment 234 may be entered manually or otherwise derived.

The perform-to-verify segment 229 may represent a time period elapsing from perform time 210 to verify time 212. For example, perform-to-verify segment 229 may represent the time that elapsed from the moment a particular test of a specimen was performed to the moment the results of the test were verified.

The perform-to-verify segment 229 may be computed from perform time 210 and verify time 212 as a difference between verify time 212 and perform time 210. Alternatively, perform-to-verify segment 229 may be entered manually or otherwise derived.

The admit-to-receive segment 223 may represent a time period elapsing from admit time 201 to receive time 206. For example, admit-to-receive segment 223 may represent the time that elapsed from the moment a patient was admitted to a medical facility to the moment a specimen from the patient was received.

The admit-to-receive segment 223 may be computed from admit time 201 and receive time 206 as a difference between receive time 206 and admit time 201. Alternatively, admit-to-receive segment 223 may be entered manually or otherwise derived.

The receive-to-bench segment 226 may represent a time period elapsing from receive time 206 to bench time 208. For example, receive-to-bench segment 226 may represent the time that elapsed from the moment the specimen was received at a medical laboratory to the moment the specimen was delivered to or placed on a bench of the technician responsible for preforming the test.

The receive-to-bench segment 226 may be computed from receive time 206 and bench time 208 as a difference between bench time 208 and receive time 206. Alternatively, receive-to-bench segment 226 may be entered manually or otherwise derived.

The bench-to-verify segment 228 may represent a time period elapsing from a moment a specimen was received at a technician bench (bench time 208) to a moment test results were verified (verify time 212). For example, bench-to-verify segment 228 may represent the time that elapsed from the moment the technician placed the specimen in a blood analyzer to the moment the blood analyzer provided the verified blood test results to the computer system. According to another example, bench-to-verify segment 228 may represent the time that elapsed from the moment a radiologist started looking at a mammogram image to the moment the radiologist verified his diagnosis and entered the verified test results into the computer system.

The bench-to-verify segment 228 may be computed from bench time 208 and verify time 212 as a difference between verify time 212 and bench time 208. Alternatively, bench-to-verify segment 228 may be entered manually or otherwise derived.

The order-to-receive segment 225 may represent a time period elapsing from order time 202 and receive time 206. For example, order-to-receive segment 225 may represent the time that elapsed from the moment a nurse entered a test order for a patient to a computer system to the moment a specimen from the patient was received.

The order-to-receive segment 225 may be computed from order time 202 and receive time 206 as a difference between receive time 206 and order time 202. Alternatively, order-to-receive time segment 225 may be entered manually or otherwise derived.

The receive-to-verify segment 227 may represent a time period elapsing from receive time 206 to verify time 212. For example, receive-to-verify segment 227 may represent the time that elapsed from the moment a particular specimen was received at a laboratory to the moment the testing results performed on the specimen were verified.

The receive-to-verify segment 227 may be computed from receive time 206 and verify time 212 as a difference between verify time 212 and receive time 206. Alternatively, receive-to-verify segment 227 may be entered manually or otherwise derived.

The collect-to-verify segment 233 may represent a time period elapsing from collect time 204 to verify time 212. For example, collect-to-verify segment 233 may represent the time that elapsed from the moment a specimen was collected from a patient to the moment the testing results performed on the specimen were verified.

The collect-to-verify segment 233 may be computed from collect time 204 and verify time 212 as a difference between verify time 212 and collect time 204. Alternatively, collect-to-verify segment 233 may be entered manually or otherwise derived.

The order-to-verify segment 232 may represent a time period elapsing from order time 202 to verify time 212. For example, order-to-verify segment 232 may represent the time that elapsed from the moment a nurse entered a test order for a patient to a computer system to the moment the testing results for the patient were verified.

The order-to-verify segment 232 may be computed from order time 202 and verify time 212 as a difference between verify time 212 and order time 202. Alternatively, order-to-verify segment 232 may be entered manually or otherwise derived.

The admit-to-verify segment 231 may represent a time period elapsing from admit time 201 and verify time 212. For example, admit-to-verify segment 231 may represent the time that elapsed from the moment a patient was admitted to a medical facility to the moment tests results performed for the patient were verified.

The admit-to-verify segment 231 may be computed from admit time 201 and verify time 212 as a difference between verify time 212 and admit time 201. Alternatively, admit-to-verify segment 231 may be entered manually or otherwise derived.

4.0 Segment Specific Rules

In an embodiment, a segment specific rule may be implemented in computer-executable logic and defines one or more actions to be performed when one or more conditions are satisfied by data of a particular time segment. Creating a segment rule may involve determining input data for the rule, conditions associated with the rule and actions that may be performed if certain conditions are satisfied. For example, a rule may define a condition for testing whether a particular time segment value is invalid and an action to be performed when the condition is satisfied by the particular time segment.

In healthcare related applications, the purpose of applying rules to measurement data may be to determine whether a particular time segment associated with a particular laboratory testing stage should be ignored in benchmarking data for the healthcare facility. For example, a segment specific rule may define when a time segment should be ignored for the purpose of benchmarking test related data.

Depending on implementation, segments rules may be simple, complex or anything in between. For example, a simple rule may rely on testing one simple condition for determining whether a particular time segment should be ignored in data benchmarking. A more complex rule may test several conditions and exceptions for determining whether one or more time segments should be ignored in data benchmarking.

In an embodiment, segment specific rules may be defined by a user, a system administrator, a system manager or a software application. The rules may be defined based on analytically derived data or empirical data. The rules may be managed or executed by a rule applying unit 155 of a managing processor 150.

In an embodiment, an objective for applying segment specific rules to time segments is to identify the TAT values that are improper for data benchmarking because their inclusion in the benchmarking could skew efficiency metrics. For example, applying the segment rules may allow determining whether one or more TATs have negative values, and if so, determine whether the respective TATs indicate data entered to a database in error.

Examples of TAT related errors may include human errors, data transmission errors or any other type errors. For example, it is possible that either a collect time or a receive time (or both) was mistyped, or the specimen was mislabeled. Such errors impact the values of TATs computed for the respective time segments, and in some circumstances, the particular TATs may be ignored in generating efficiencies metrics.

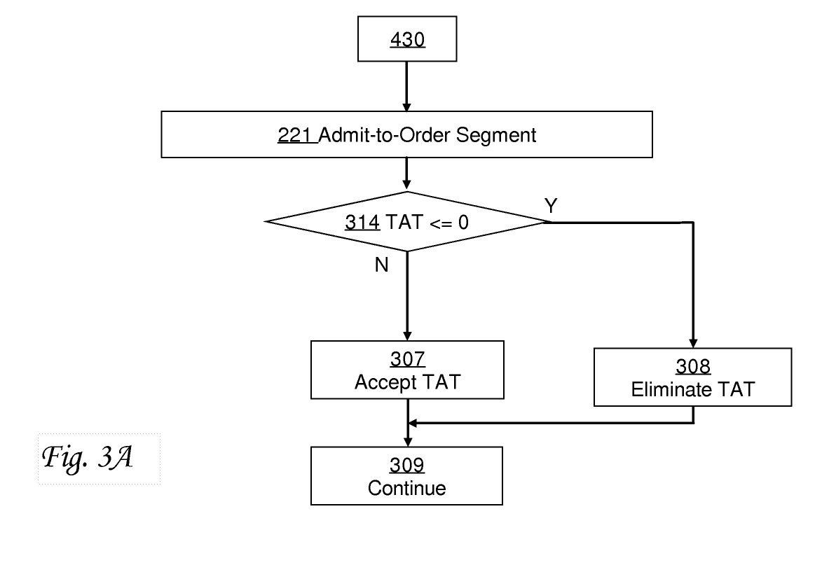

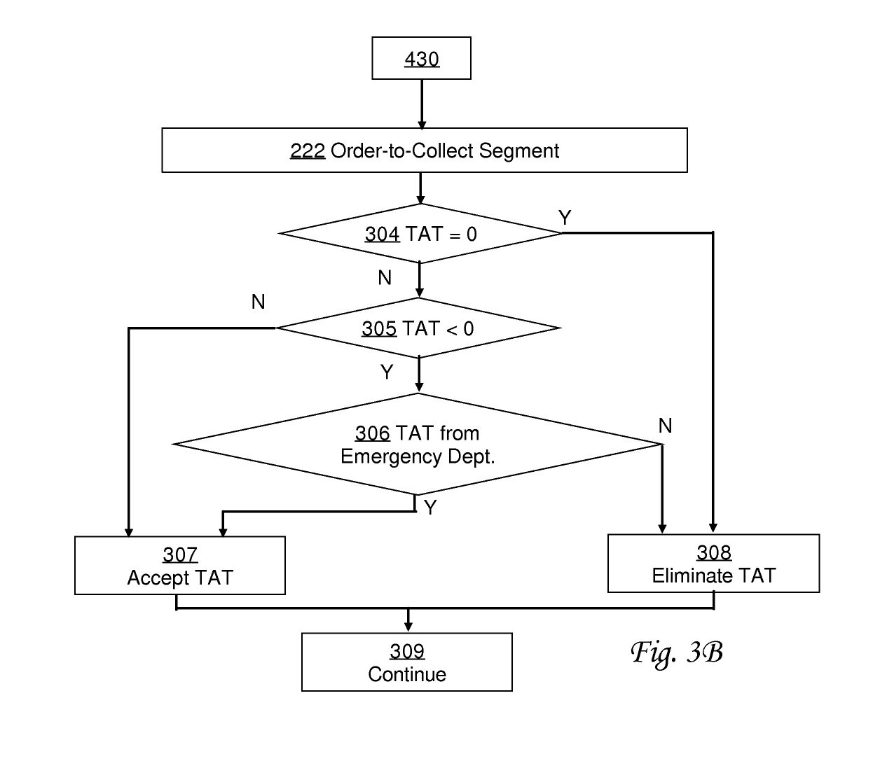

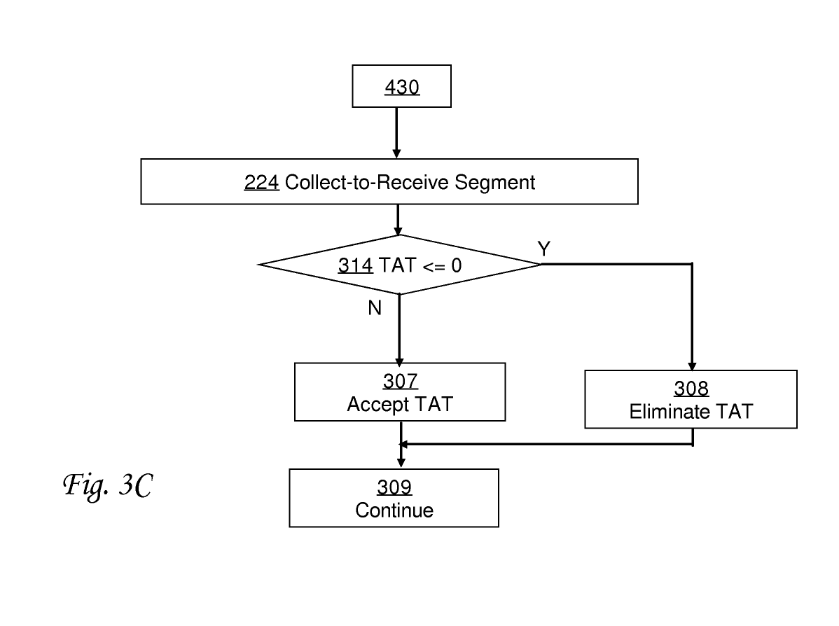

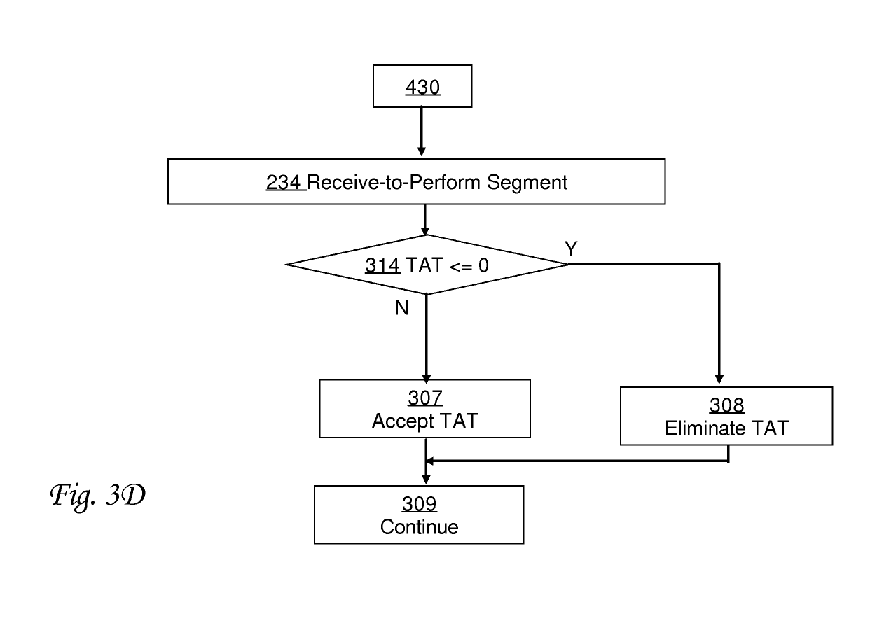

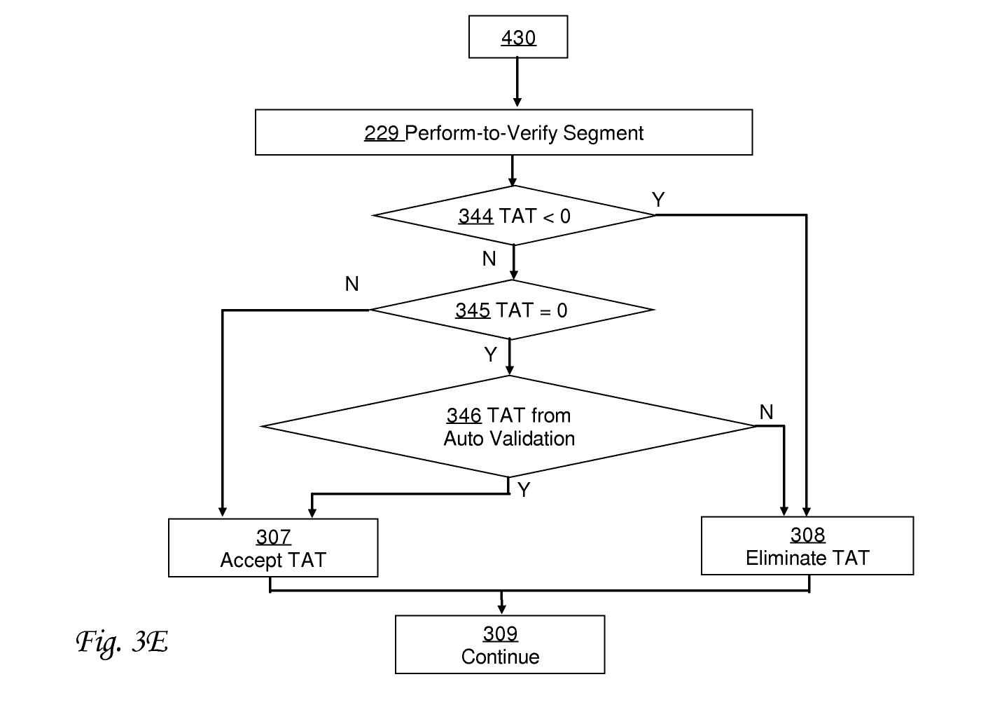

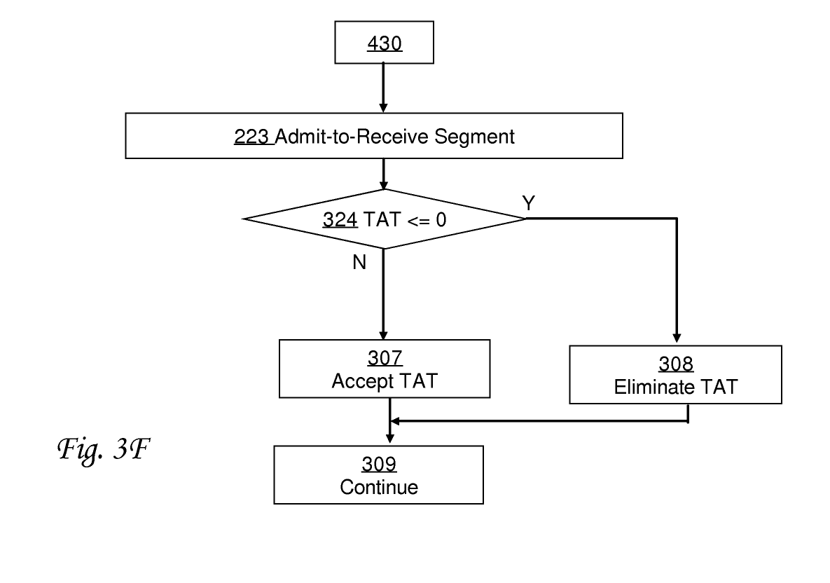

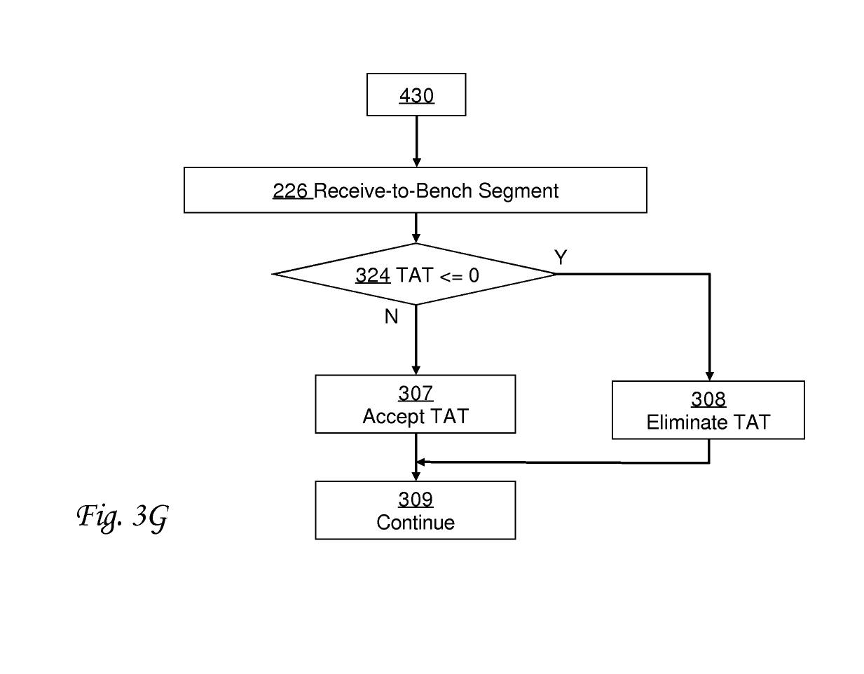

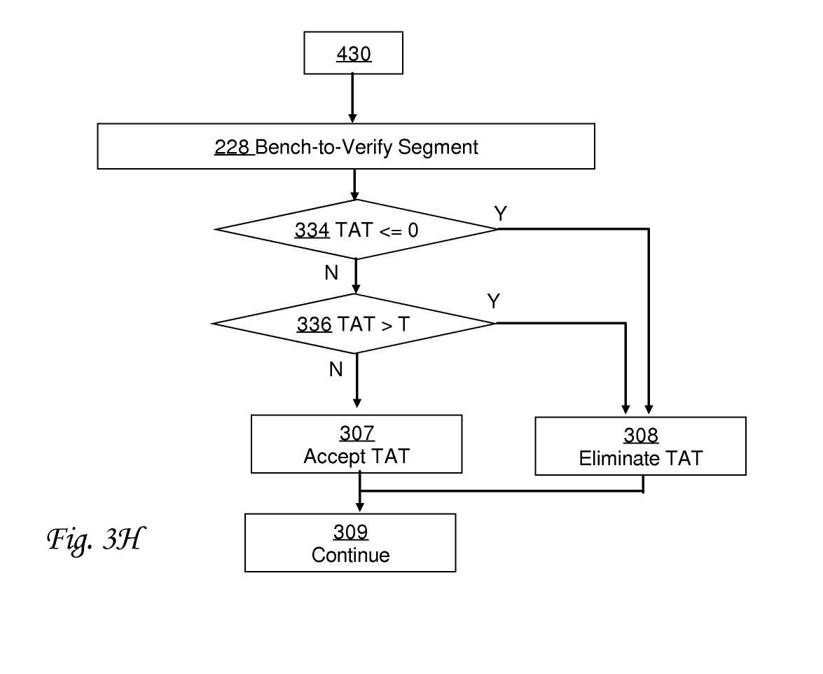

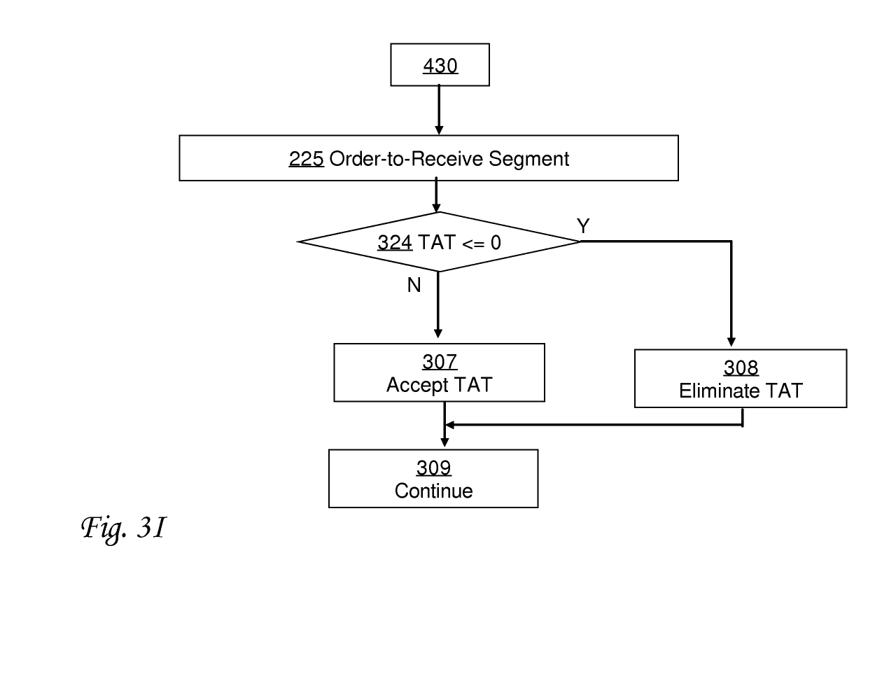

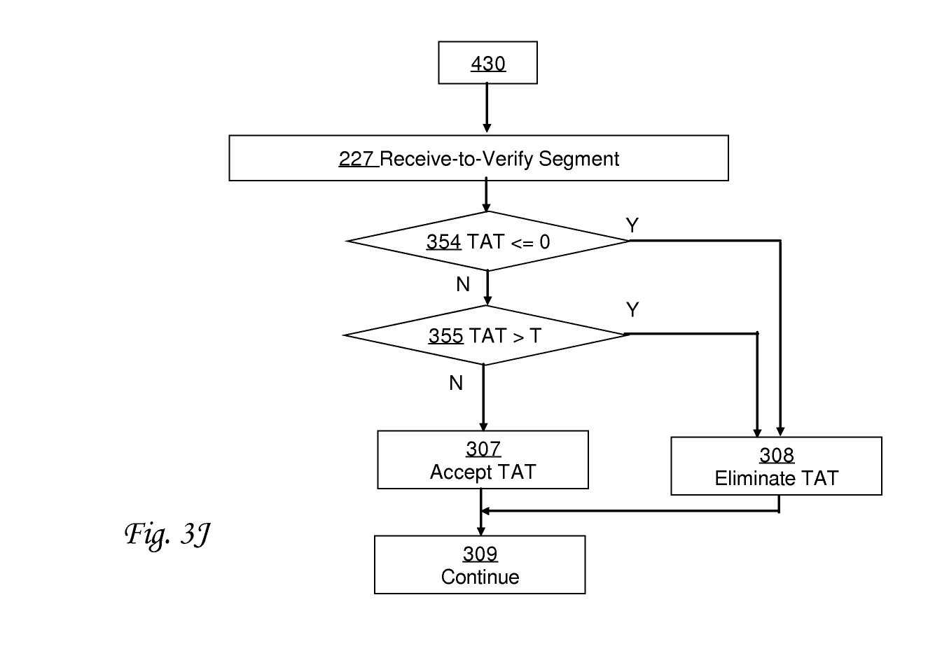

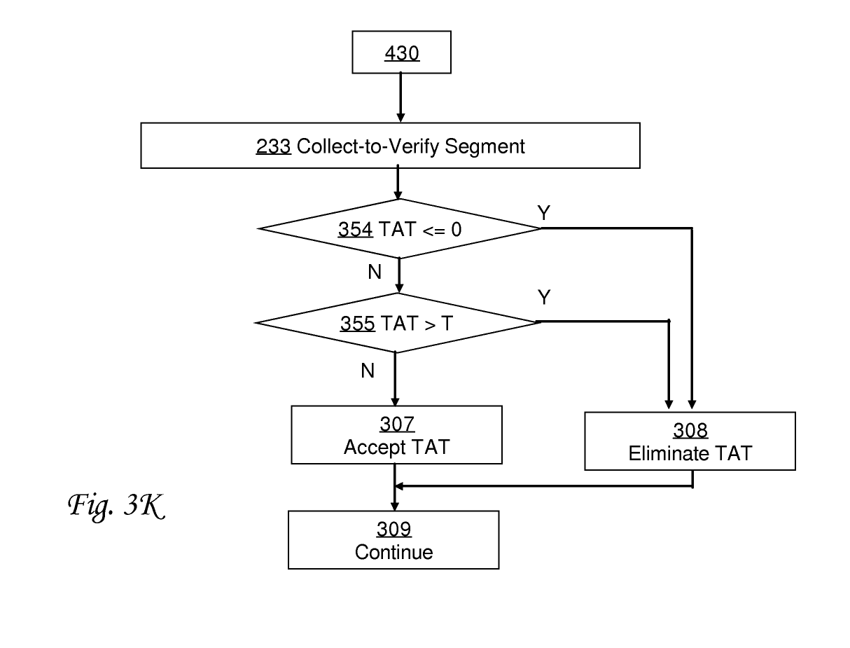

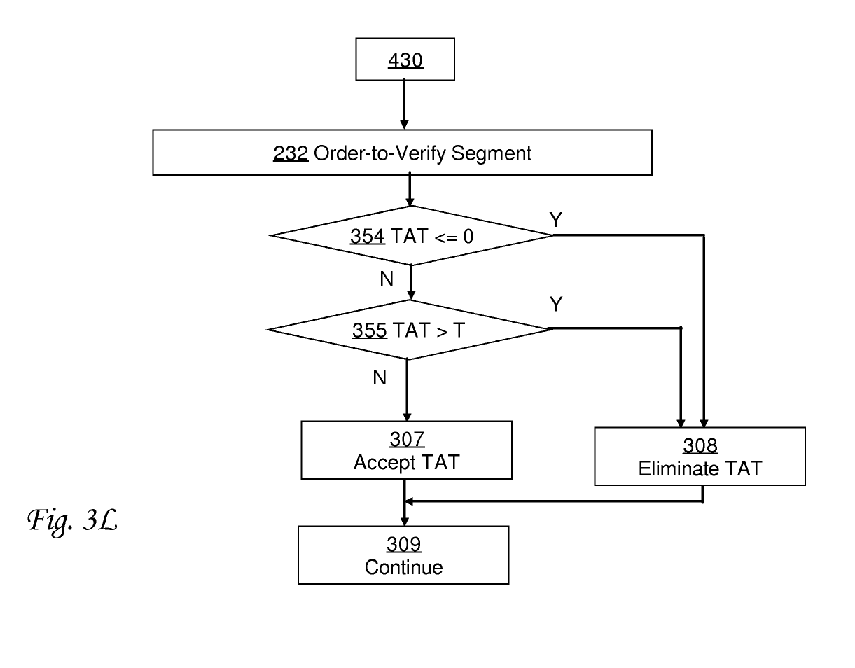

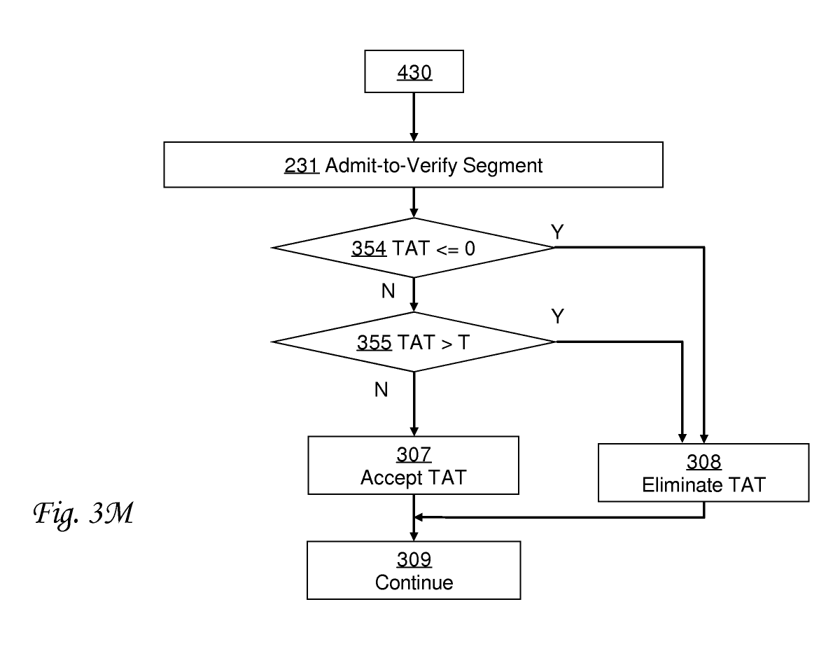

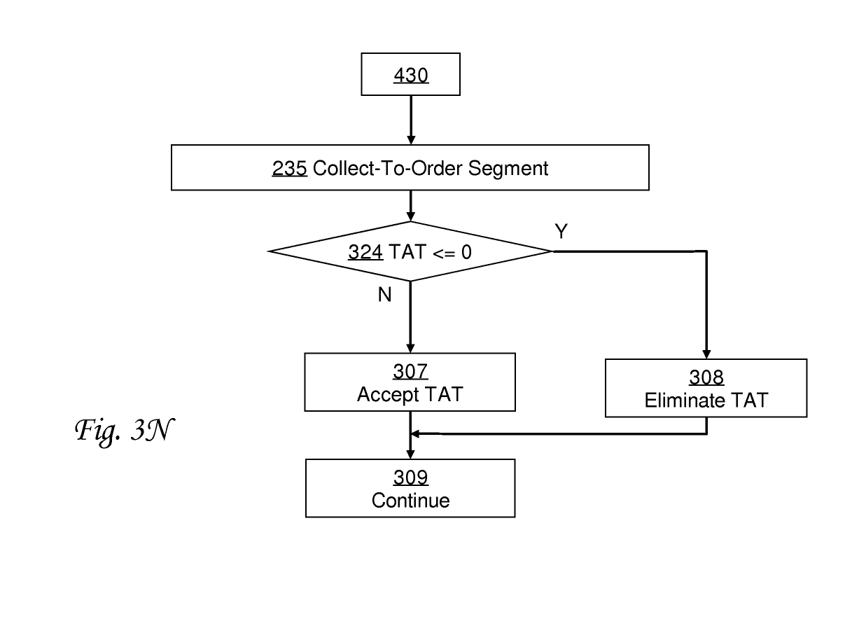

FIG. 3A-FIG. 3N illustrate various embodiments of segment rules for modifying time data values. Examples depicted in FIG. 3A-3N comprise several rules defined for the time segments described in FIG. 2. The examples depicted in FIG. 3A-3N are provided merely for illustrating some of many possible segment rules. The disclosure is not viewed as limited to just the rules depicted in FIG. 3A-3N. Instead, the depicted segment rules may be modified or otherwise expanded to capture specific characteristics of the benchmarked data.

FIG. 3A depicts examples of segment rules applicable to the admit-to-order segment 221. The depicted rules test a TAT value computed for the admit-to-order segment 221 and take into account the circumstances for which the admit-to-order segment 221 was determined.

A TAT for the admit-to-order segment 221 may have a positive value, a zero value or a negative value. A positive value may represent a typical situation in which a patient is admitted to a medical facility before any tests are ordered for the patient. The value may be very large if the time period between admitting the patient and ordering the tests for the patient is very long. This may happen due to for example, an unusual number of the patients admitted at the same time, an insufficient number of medical professionals available to see the patients, or problems in routing the admitted patients to the medical professionals.

If a TAT value for admit-to-order segment 221 has a non-positive value, then that may indicate a data entry error or some other abnormality. For example, it may be difficult to foresee a situation in which a patient is admitted to a medical facility after a test was ordered for the patient.

At step 314, it is tested whether a TAT value associated with the admit-to-order segment 221 is zero or negative. If it is, then at step 308, the TAT is eliminated from the set of TAT values used to compute benchmarking results. The reasoning behind such a rule is that it is rather impossible to order a test of a patient who has not been admitted to the medical facility yet.

However, if at step 314 it is determined that a TAT value associated with the admit-to-order segment 221 is positive, then the TAT value is accepted in computing benchmarking results.

At step 309, application of the rules continues for TAT values for other segments.

FIG. 3B depicts examples of segment rules applicable to an order-to-collect segment 222. The depicted rules test a TAT value computed for order-to-collect time segment 222 and take into account the circumstances for which order-to-collect time segment 222 was determined.

In some situations, a TAT value for order-to-collect time segment 222 may be a relatively small positive value. For example, the TAT value for order-to-collect time segment 222 may be small if during a patient visit at a clinic, a particular blood test was ordered and the blood specimen for the test was drawn from the patient shortly after the test was ordered. In such circumstances, the TAT value for may be in a range of minutes or hours. Most likely, such a TAT value may be acceptable in computing efficiency metrics.

In some other situations, a TAT value for order-to-collect segment 222 may be a relatively large positive value. For example, a TAT value may be large if a particular blood test was ordered on one day, but a blood specimen was drawn a couple of weeks or months later. This may happen when the patient had to schedule an appointment with a test laboratory and encountered some scheduling problems. The problems may be caused either by the patient, by the laboratory, or both. In such circumstances, the TAT value may be in a range of weeks or even months and may be acceptable in computer efficiency metrics; however, because it is a large positive value, for the purpose of data benchmarking, it may indicate that there are some problems in the laboratory.

In yet other situations, a TAT for order-to-collect segment 222 may be a zero (0) or a negative value when the corresponding timestamps were entered incorrectly. This may happen due to a human error in entering the time data. For example, a timestamp value might have been entered incorrectly, or the computer clock was malfunctioning, or some other problems occurred. In particular, if an operator enters the same value for collect time 204 and for order time 202, then order-to-collect segment 222 may be zero (0). According to another example, if an operator enters incorrect either order time 202 or collect time 204 so that order time 202 is greater than collect time 204, then order-to-collect segment 222 may have a negative value. The examples of the rules below allow determining that such a TAT value should be ignored for the purpose of data benchmarking, unless the TAT is not associated with an emergency department.

At step 304, it is tested whether a TAT associated with order-to-collect segment 222 has a value of zero. If the TAT is zero, then at step 308, the TAT is eliminated from the set of TAT values used to compute benchmarking results. The reasoning behind such a rule is that it is rather impossible to order a test and collect a specimen for the test at the same time. Usually, the test for a patient is ordered first, and a specimen is collected from the patient later. However, if the TAT is zero, then most likely the corresponding timestamps were entered in error.

At step 305, it is tested whether a TAT value associated with order-to-collect segment 222 is negative. If the TAT is negative, then at step 306 it is tested whether the TAT is associated with collecting a specimen for a test at an emergency department. If it is, then at step 307, the TAT value is accepted in computing benchmarking results. This rule addresses an exception applicable to TATs for the tests ordered in emergency situation cases. In an emergency situation, a specimen may be collected immediately in response to instructions from an emergency physician; however, a test order itself may be entered into a system database sometime after the specimen was collected. In such a situation, order time 202 is greater than collect time 204 because the specimen was collected before the test order itself was entered into the system. However, even if the TAT has a negative value, the value may be acceptable because of the exceptional circumstances in which the test was ordered.

However, if a TAT value is not positive, but exceptional circumstances do not apply, then at step 308, the TAT is eliminated from the set of TAT values used to compute benchmarking results.

If at step 305 it is determined that TAT is not a negative value (and that it is not zero, as tested at step 304), then the TAT is accepted in computing benchmarking results.

At step 309, application of the rules continues for TAT values for other segments.

FIG. 3C depicts examples of segment rules applicable to a collect-to-receive segment 224. The depicted rules test a TAT value computed for collect-to-receive time segment 224 and take into account the circumstances for which collect-to-receive time segment 224 was determined.

A TAT for collect-to-receive segment 224 may have a positive value, a zero value or a negative value. A positive value may represent a typical situation in which a collection of a specimen takes place before the specimen is received at a laboratory. The value may be very large if delivering the specimen from the collection station to the laboratory took a long time. This may happen due to for example, a large distance between the specimen collection station and the laboratory.

If a TAT value for collect-to-receive segment 224 has a non-positive value, then that may indicate a data entry error or some other abnormality. For example, it may be difficult to foresee a situation in which a specimen is received at a laboratory before the specimen was actually collected.

At step 314, it is tested whether a TAT value associated with collect-to-receive segment 224 is zero or negative. If it is, then at step 308, the TAT is eliminated from the set of TAT values used to compute benchmarking results. The reasoning behind such a rule is that it is rather impossible to receive at a laboratory a specimen for a test before the specimen is collected from a patient.

However, if at step 314 it is determined that a TAT value associated with collect-to-receive segment 224 is positive, then the TAT value is accepted in computing benchmarking results.

At step 309, application of the rules continues for TAT values for other segments.

FIG. 3D depicts examples of segment rules applicable to a receive-to-perform segment 234. The depicted rules test a TAT value computed for receive-to-perform segment 234 and take into account the circumstances for which receive-to-perform segment 234 was determined.

A TAT for receive-to-perform segment 234 may have a positive value, a zero value or a negative value. A positive value may represent a typical situation in which a specimen for a patient is received before a test on the specimen is performed. The value may be very large if the laboratory is understaffed or overwhelmed with work.

If a TAT value for receive-to-perform segment 234 has a non-positive value, then that may indicate a data entry error or some other abnormality. For example, it may be difficult to foresee a situation in which a test on a specimen is performed before the specimen is actually collected from a patient.

At step 314, it is tested whether a TAT value associated with receive-to-perform segment 234 is zero or negative. If it is, then at step 308, the TAT is eliminated from the set of TAT values used to compute benchmarking results.

However, if at step 314 it is determined that a TAT value associated with receive-to-perform segment 234 is positive, then the TAT value is accepted in computing benchmarking results.

At step 309, application of the rules continues for TAT values for other segments.

FIG. 3E depicts examples of segment rules applicable to a perform-to-verify segment 229. The depicted rules test a TAT value computed for perform-to-verify segment 229 and take into account the circumstances for which perform-to-verify segment 342 was determined.

A TAT for perform-to-verify segment 229 may have a value that is positive, zero or negative. If perform-to-verify segment 229 has a non-positive value, then that may indicated that the timestamps were entered incorrectly.

At step 344, it is tested whether a TAT value associated with perform-to-verify segment 229 is negative. If it is, then the TAT is eliminated from computing benchmarking results.

However, if a TAT value associated with perform-to-verify segment 229 is not negative, then at step 345, it is tested whether the TAT is zero. If it is, then at step 346, it is tested whether the TAT is associated with an auto-validation of the test results. If the TAT is associated with the auto-validation of the test results, then the TAT is accepted in computing benchmarking results. The reasoning behind such a rule is that in case of the auto-validation, the validation of the test results may be performed very quickly so the timestamp for the auto-validation and the timestamp for performance of the test itself may be the same. Thus, in case of the auto-validation, a TAT having a zero as a value may still be a correct TAT, and thus acceptable in computing benchmarking results.

If at step 345, it is determined that a TAT value associated with perform-to-verify segment 229 is positive, then the TAT is accepted in computing benchmarking results.

However, if at step 346, it is determined that a TAT value associated with perform-to-verify segment 229 is zero but it is not associated with an auto-validation of the test results, then the TAT is eliminated from computing benchmarking results.

At step 309, application of the rules continues for TAT values for other segments.

FIG. 3F depicts examples of segment rules applicable to an admit-to-receive segment 223. The depicted rules test a TAT value computed for admit-to-receive segment 223 and take into account the circumstances for which admit-to-receive segment 223 was determined.

A TAT for admit-to-receive segment 223 may have a positive value, a zero value or a negative value. A positive value may represent a typical situation in which a specimen for a patient is received after the patient is admitted to a medical laboratory. The value may be very large if the laboratory is understaffed or overwhelmed with work.

If a TAT value for admit-to-receive segment 223 has a non-positive value, then that may indicate a data entry error or some other abnormality. For example, it may be difficult to foresee a situation in which a specimen was received from a patient before the patient was admitted to a medical facility.

At step 314, it is tested whether a TAT value associated with admit-to-receive segment 223 is zero or negative. If it is, then at step 308, the TAT is eliminated from the set of TAT values used to compute benchmarking results.

However, if at step 314 it is determined that a TAT value associated with admit-to-receive segment 223 is positive, then the TAT value is accepted in computing benchmarking results.

At step 309, application of the rules continues for TAT values for other segments.

FIG. 3G depicts examples of segment rules applicable to a receive-to-bench segment 226. The depicted rules test a TAT value computed for receive-to-bench segment 226 and take into account the circumstances for which receive-to-bench segment 226 was determined.

A TAT for a receive-to-bench segment 226 may have a positive value, a zero value or a negative value. A positive TAT may represent a typical situation when a specimen is placed on a laboratory bench after the specimen was received at a laboratory. The value may be very large if delivering the specimen from the laboratory receiving-desk to the laboratory bench took an unusually long time. This may occur when for example, the laboratory is understaffed or the laboratory employed too few technicians specializing in performing a particular test, or in some other circumstances.

However, if a TAT for a receive-to-bench segment 226 has a non-positive value, then that may indicate that the corresponding timestamps were entered incorrectly.

At step 324, it is tested whether a TAT value associated with receive-to-bench segment 226 is zero or negative. If it zero or negative, then at step 308, the TAT is eliminated from a set of TAT values used to compute benchmarking results. The reasoning behind such a rule is that it is rather impossible to place a specimen at a laboratory bench before the specimen is received at the laboratory.

However, if at step 324 it is determined that a TAT value associated with receive-to-bench segment 226 is positive, then the TAT value is accepted in computing benchmarking results.

At step 309, application of the rules continues for TAT values for other segments.

FIG. 3H depicts examples of segment rules applicable to a bench-to-verify segment 228. The depicted rules test a TAT value computed for bench-to-verify segment 228 and take into account the circumstances for which bench-to-verify segment 332 was determined.

A TAT for bench-to-verify time segment 228 may have a value that is positive, zero or negative. If bench-to-verify time segment 228 has a non-positive value, then that may indicate that the timestamps were entered incorrectly.

A positive TAT may represent a typical situation when after a specimen was delivered to a laboratory technician, the technician performs a test on the received specimen, verifies it, and enters the test results into the computer system. The value may be very large if performing the specimen test and/or verifying the test results took a long time. This may occur when for example, the laboratory is understaffed or the laboratory employs too few technicians specializing in performing a particular test, or some other circumstances.

However, an unusually large a TAT for bench-to-verify segment 228 may indicate presence of data entry errors or some other abnormality. For example, either bench time 208 or verify time 212 (or both) was entered incorrectly, or some computer glitch introduced an error into the respective timestamps. In such situations, a threshold value “T” may be used to determine whether the unusually large TAT may be acceptable or may be treated as inappropriate.

A threshold value “T” indicates a cut off value for a TAT value. A value for the T needs to be selected in such a way that a TAT value lower than (or equal to) T may still be acceptable for the purpose of computing benchmarked results, but a TAT value greater than T may not be acceptable for the purpose of computing the benchmarking results.

A threshold T may be applicable in “add-on-testing,” in which performance of one or more additional tests is requested after a specimen has been already received at a laboratory bench. For example, it may be necessary to perform one or more additional blood tests after an already performed test of the specimen indicated a need for additional testing. In such circumstances, the specimen may be already available at the laboratory, and thus adding an additional test of the specimen may be straightforward. However, a TAT value associated with a bench-to-verify segment 228 for the add-on-test may be large. Nevertheless, the TAT still should be capped by a threshold T to distinguish valid TATs from those that might have been merely erroneously entered data.

A threshold T may be determined empirically based on various testing cases, or otherwise. For example, in some implementations, a T may be chosen as any number between 240 minutes and 360 minutes. Thus, if T is chosen as 240 minutes, then a TAT value that is less than (or equal to) 240 minutes is acceptable in benchmarking, but a TAT that is greater than 240 minutes is not acceptable for the purpose of benchmarking.

At step 334, it is tested whether a TAT value associated with bench-to-verify segment 228 is non-positive. If it is non-positive, then the TAT is eliminated from computing benchmarking results.

However, if at step 334, it is determined that a TAT value is non-positive, then at step 336, it is tested whether the TAT value is greater than a threshold value “T,” and if so, the TAT value is eliminated from a set of TAT values used to compute benchmarking results. The reasoning behind such a rule is that an extraordinarily long TAT for a bench-to-verify segment 228 must have been caused by erroneously typed respective timestamps, or by some other errors.

If at step 336, it is determined that a TAT is positive but does not exceed a threshold “T,” then the TAT is accepted in computing benchmarking results.

At step 309, application of the rules continues for TAT values for other segments.

FIG. 3I depicts examples of segment rules applicable to an order-to-receive segment 225. The depicted rules test a TAT value computed for order-to-receive segment 225 and take into account the circumstances for which order-to-receive segment 225 was determined.

A TAT for order-to-receive segment 225 may have a positive value, a zero value or a negative value. A positive value may represent a typical situation in which a specimen for a patient is received after the patient a test of the specimen was ordered. The value may be very large if the laboratory is understaffed or overwhelmed with work.

If a TAT value for order-to-receive segment 225 has a non-positive value, then that may indicate a data entry error or some other abnormality. For example, it may be difficult to foresee a situation in which a specimen was received from a patient before a test of the specimen was ordered for the patient.

At step 314, it is tested whether a TAT value associated with order-to-receive segment 225 is zero or negative. If it is, then at step 308, the TAT is eliminated from the set of TAT values used to compute benchmarking results.

However, if at step 314 it is determined that a TAT value associated with order-to-receive segment 225 is positive, then the TAT value is accepted in computing benchmarking results.

At step 309, application of the rules continues for TAT values for other segments.

FIG. 3J depicts examples of segment rules applicable to a receive-to-verify segment 227. The depicted rules test a TAT value computed for receive-to-verify segment 227 and take into account the circumstances for which perform-to-verify segment 352 was determined.

A TAT for receive-to-verify segment 227 may have a value that is positive, zero or negative. If receive-to-verify segment 227 has a non-positive value, then that may indicate that the timestamps were entered incorrectly.

At step 354, it is tested whether a TAT value for receive-to-verify time segment 227 is non-positive. If it is, then at step 308, the TAT is eliminated from computing benchmarking results. The reasoning behind such a rule is that typically a specimen is received at a laboratory before the test of the specimen is performed and the results of the test are verified. Thus, receive-to-verify time segment 227 most likely should be positive or at least zero, and a TAT that is non-positive most likely indicates an error in entering respective timestamps.

At step 355, it is tested whether a TAT associated with receive-to-verify segment 227 is greater than a threshold value “T.” T threshold was described above. If the TAT is greater than TAT, then, at step 308, the TAT is eliminated from a set of TATs used in benchmarking because most likely the TAT is so excessive that it cannot even be caused by an add-on-testing.

However, if a positive TAT is lesser than T, then, at step 307, the TAT is accepted for the purpose of computing benchmarked results. The reasoning behind such a rule is that if the TAT has a positive value, then only the TAT lesser than T should be used in benchmarking because those TAT may be associated with “add-on-testing.” For example, if a specimen is received at a laboratory for testing, during the testing, it may be determined that an additional test needs to be performed on the specimen and these results of the additional test need to be verified. In such circumstances, the TAT may still be included in computing benchmarking results.

At step 309, application of the rules continues for TAT values for other segments.

FIG. 3K depicts examples of segment rules applicable to a collect-to-verify segment 233. The depicted rules test a TAT value computed for collect-to-verify segment 233 and take into account the circumstances for which collect-to-verify segment 233 was determined.

A TAT for collect-to-verify segment 233 may have a value that is positive, zero or negative. If collect-to-verify segment 233 has a non-positive value, then that may indicate that the timestamps were entered incorrectly.

At step 354, it is tested whether a TAT value for collect-to-verify segment 233 is non-positive. If it is, then at step 308, the TAT is eliminated from computing benchmarking results. The reasoning behind such a rule is that typically a specimen is collected at a laboratory before the test of the specimen is performed and the results of the test are verified. Thus, collect-to-verify segment 233 most likely should be positive or at least zero, and a TAT that is non-positive most likely indicates an error in entering respective timestamps.

At step 355, it is tested whether a TAT associated with collect-to-verify segment 233 is greater than a threshold value “T.” T threshold was described above. If the TAT is greater than TAT, then, at step 308, the TAT is eliminated from a set of TATs used in benchmarking because most likely the TAT is so excessive that it cannot even be caused by an add-on-testing.

However, if a positive TAT is lesser than T, then, at step 307, the TAT is accepted for the purpose of computing benchmarked results. The reasoning behind such a rule is that if the TAT has a positive value, then only the TAT lesser than T should be used in benchmarking because those TAT may be associated with “add-on-testing.” For example, if a specimen is collected at a laboratory for testing, during the testing, it may be determined that an additional test needs to be performed on the specimen and these results of the additional test need to be verified. In such circumstances, the TAT may still be included in computing benchmarking results.

At step 309, application of the rules continues for TAT values for other segments.

FIG. 3L depicts examples of segment rules applicable to an order-to-verify segment 232. The depicted rules test a TAT value computed for order-to-verify segment 232 and take into account the circumstances for which order-to-verify segment 232 was determined.

A TAT for order-to-verify segment 232 may have a value that is positive, zero or negative. If order-to-verify segment 232 has a non-positive value, then that may indicate that the timestamps were entered incorrectly.

At step 354, it is tested whether a TAT value for order-to-verify segment 232 is non-positive. If it is, then at step 308, the TAT is eliminated from computing benchmarking results. The reasoning behind such a rule is that typically a test of a specimen is usually ordered before the test of the specimen is performed and the results of the test are verified. Thus, order-to-verify segment 232 most likely should be positive or at least zero, and a TAT that is non-positive most likely indicates an error in entering respective timestamps.

At step 355, it is tested whether a TAT associated with order-to-verify segment 232 is greater than a threshold value “T.” T threshold was described above. If the TAT is greater than TAT, then, at step 308, the TAT is eliminated from a set of TATs used in benchmarking because most likely the TAT is so excessive that it cannot even be caused by an add-on-testing.

However, if a positive TAT is lesser than T, then, at step 307, the TAT is accepted for the purpose of computing benchmarked results. The reasoning behind such a rule is that if the TAT has a positive value, then only the TAT lesser than T should be used in benchmarking because those TAT may be associated with “add-on-testing.” For example, if a specimen is collected at a laboratory for testing, during the testing, it may be determined that an additional test needs to be performed on the specimen and these results of the additional test need to be verified. In such circumstances, the TAT may still be included in computing benchmarking results.

At step 309, application of the rules continues for TAT values for other segments.

FIG. 3M depicts examples of segment rules applicable to an admit-to-verify segment 231. The depicted rules test a TAT value computed for admit-to-verify segment 231 and take into account the circumstances for which admit-to-verify segment 231 was determined.

A TAT for admit-to-verify segment 231 may have a value that is positive, zero or negative. If admit-to-verify segment 231 has a non-positive value, then that may indicate that the timestamps were entered incorrectly.

At step 354, it is tested whether a TAT value for admit-to-verify segment 231 is non-positive. If it is, then at step 308, the TAT is eliminated from computing benchmarking results. The reasoning behind such a rule is that typically a patient is admitted to a medical facility before a test of a specimen from the patient is performed and the results of the test are verified. Thus, admit-to-verify segment 231 most likely should be positive or at least zero, and a TAT that is non-positive most likely indicates an error in entering respective timestamps.

At step 355, it is tested whether a TAT associated with admit-to-verify segment 231 is greater than a threshold value “T.” T threshold was described above. If the TAT is greater than TAT, then, at step 308, the TAT is eliminated from a set of TATs used in benchmarking because most likely the TAT is so excessive that it cannot even be caused by an add-on-testing.

However, if a positive TAT is lesser than T, then, at step 307, the TAT is accepted for the purpose of computing benchmarked results. The reasoning behind such a rule is that if the TAT has a positive value, then only the TAT lesser than T should be used in benchmarking because those TAT may be associated with “add-on-testing.” For example, if a specimen is collected at a laboratory for testing, during the testing, it may be determined that an additional test needs to be performed on the specimen and these results of the additional test need to be verified. In such circumstances, the TAT may still be included in computing benchmarking results.

At step 309, application of the rules continues for TAT values for other segments.

FIG. 3N depicts examples of segment rules applicable to the collect-to-order segment 235. The depicted rules test a TAT value computed for the collect-to-order segment 235 and take into account the circumstances for which the collect-to-order segment 235 was determined.

The collect-to-order segment 235 may represent a time period elapsing from collect time 204 to order time 202. Conventionally, an order to collect a specimen from a patient is placed first, and the specimen is collected next. However, in some emergency situations, the specimen is collected and sent to a lab as soon as the patient arrives, and the order to collect the specimen is placed by the medical staff after the specimen is collected. For example, if a patient is admitted to an emergency room at 3 PM, in an emergency situation, a particular specimen may be collected from a patient at 3:15 PM (collect time 204), but an order for collecting the specimen may be placed by the medical staff at 3:30 PM (order time 202). Hence, in this example, collect-to-order segment 235, computed as a difference between order time 202 and collect time 204, is 15 minutes.

In ER cases, if a TAT value for collect-to-order segment 235 has a non-positive value, then that may indicate a data entry error or some other abnormality. At step 314, it is tested whether a TAT value associated with the collect-to-order segment 235 is zero or negative. If it is, then at step 308, the TAT is eliminated from the set of TAT values used to compute benchmarking results. However, if at step 314 it is determined that a TAT value associated with the admit-to-order segment 221 is positive, then the TAT value is accepted in computing benchmarking results.

5.0 Modifying Time Data Values Based on Segment Specific Rules

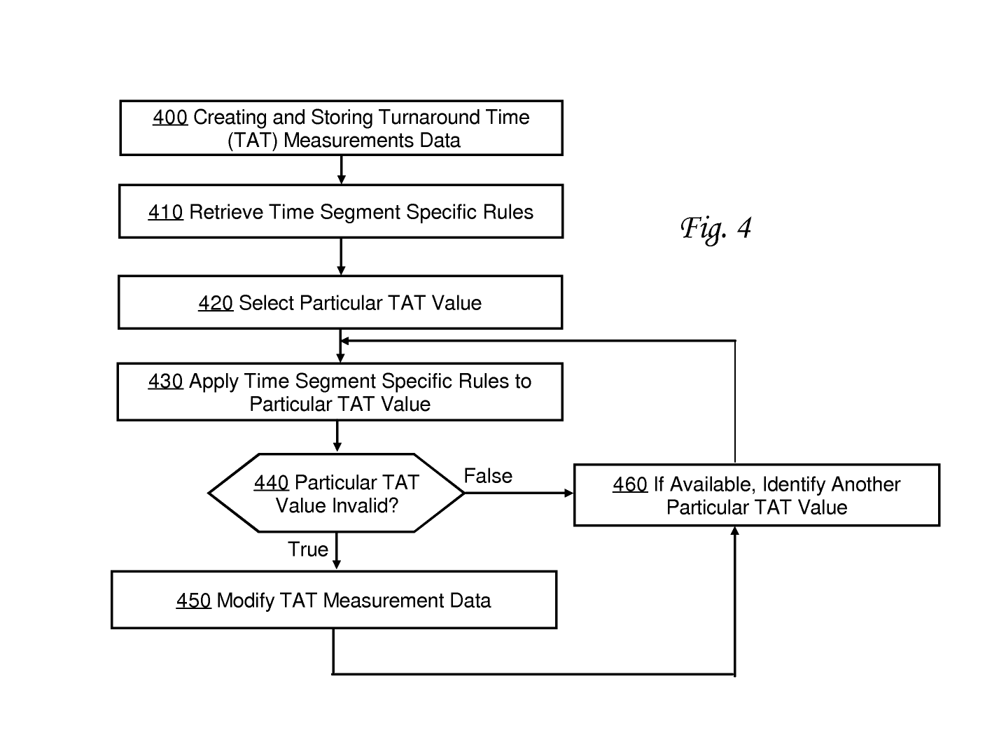

FIG. 4 illustrates an embodiment of a process flow for modifying time data values based on segment rules.

At step 400, TAT measurement data comprising one or more TAT values are created and stored for one or more time segments associated with one or more laboratory sample processing stages in a testing laboratory. For example, upon receiving laboratory performance data comprising timestamps, for a particular laboratory sample processing stage, a particular TAT value, from the one or more TAT values, is computed and associated with a particular time segment. Various methods for computing TAT values are described above. The TAT measurement data may be stored in a database 140 depicted in FIG. 1, and then provided to a management processor 150, also depicted in FIG. 1.

At step 410, one or more time segment specific rules are retrieved. The rules are described in detail in the sections above.

At step 420, a particular TAT value is selected for a particular laboratory sample processing stage and associated with a particular time segment, from the one or more time segments.

At step 430, one or more time segment specific rules are applied to the particular TAT value associated with the particular time segment to determine whether the particular TAT value is invalid. Various examples of applying the rules to the TAT values are described in detail in the sections above.

At step 440, it is determined whether, based on the application of the one or more time segment specific rules to the particular TAT value, it has been determined that the particular TAT value is invalid. If the TAT is determined to be invalid, then the process proceeds to step 450; otherwise, the process proceeds to step 460.

At step 450, the TAT measurement data for the particular time segment for the particular stage in a laboratory testing is modified by removing the TAT value that was determined as invalid at step 450.

At step 460, it is determined whether all of the TAT measurement data has been processed, and if not, then another particular TAT value, from the TAT measurement data, is identified and the process of applying the rules to the particular TAT value (step 430) and determining whether to modify the TAT measurement data (steps 440-450) are repeated for all TAT measurement data.

Once it the process of modifying time data values based on segment specific rules is completed, a report may be generated based on the modified values. The modified data may represent the values that are meaningful of typographical errors and other errors that inappropriately may skew performance metrics generated for a tested facility. For example, by application of one or more sets of segment rules (as those depicted in FIG. 3A-3N, above) the TAT values that are deemed to be incorrect are eliminated and not used in generating the performance metrics.

Performance metrics generated from modified time data values may be provided to management of the facility to review. The format of the performance metric may be any of known data report formats known in the industry. A report may depict a TAT performance summary representing a variety of time spans. For example, a TAT performance summary may span an hour, a day, a month, a few months, a year, or any other time duration. A report may depict TAT trends within the specified time span and include actual, averaged or otherwise combined TAT values for the specified time span. Furthermore, a report may depict a target (desired) TAT values for the specified time span, a baseline, a historical performance, daily TAT values, and other statistical data useful to the management.

Summary statistics included in a report may include a day average TAT, a median TAT, a 50th percentile TAT, and one or more outliers depicting TATs above a target value. The target and baseline TAT performance data can be compared against the current TAT values, and various graphical representations of TAT trends may be included in a report.

6.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

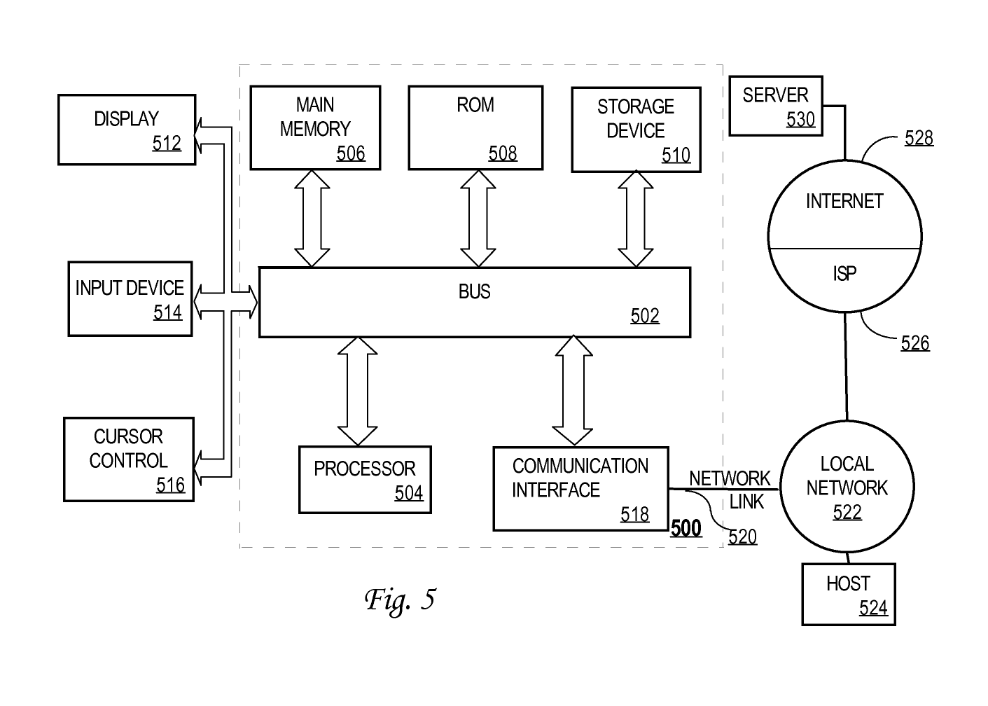

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (LCD, CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A method, comprising:
creating and storing test turnaround time (TAT) measurement data comprising one or more TAT values for one or more time segments associated with one or more laboratory sample processing stages in a testing laboratory;
wherein, for a particular laboratory sample processing stage, a particular TAT value, from the one or more TAT values, is associated with a particular time segment, from the one or more time segments;
applying one or more time segment specific rules to the particular TAT value associated with the particular time segment to determine whether the particular TAT value is invalid;
in response to determining that the particular TAT value is invalid, modifying the TAT measurement data for the particular time segment for the particular stage by removing the particular TAT value from the TAT measurement data;
repeating the applying and the modifying for all the TAT measurement data;
wherein the method is performed by one or more computing devices.

2. The method of claim 1, further comprising:
determining a type of the particular time segment and storing the type in association with the particular time segment;
wherein the type is any one of: admit-to-order, order-to-collect, order-to-collect, collect-to-receive, receive-to-perform, perform-to-verify, admit-to-receive, receive-to-bench, bench-to-verify, order-to-receive, receive-to-verify, collect-to-verify, order-to-verify, and admit-to-verify;
in response to determining that the type of the particular time segment is the admit-to-order, the collect-to-receive, the receive-to-bench, the receive-to-perform, the admit-to-receive, the order-to-receive, or the collect-to-order, removing the particular TAT value from the TAT measurement data in response to determining that the particular TAT value is non-positive.

3. The method of claim 2, further comprising, in response to determining that the type of the particular time segment is the order-to-collect, removing the particular TAT value from the TAT measurement data in response to determining that the particular TAT value is non-positive and not associated with an emergency department testing.

4. The method of claim 2, further comprising, in response to determining that the type of the particular time segment is the bench-to-verify, receive-to-verify, admit-to-verify, order to verify, or collect-to-verify, removing the particular TAT value from the TAT measurement data in response to determining that the particular TAT value is non-positive or that the particular TAT value is positive but does not exceed a threshold value.

5. The method of claim 2, further comprising, in response to determining that the type of the particular time segment is the perform-to-verify, removing the particular TAT value from the TAT measurement data in response to determining that the particular TAT value is negative or that the particular TAT value is zero and associated with an auto-validation.

6. The method of claim 2, further comprising, in response to determining that the type of the particular time segment is the receive-to-verify, removing the particular TAT value from the TAT measurement data in response to determining that the particular TAT value is non-positive or that the particular TAT value is positive but does not exceed the threshold value.

7. The method of claim 2, further comprising, based, at least in part, on the TAT measurement data, generating one or more outlier graphical screen displays in a computer display unit that represent the particular laboratory sample processing stage occurring within one or more time intervals, and that depict the one or more time segments, each particular TAT time for each particular time segment from the one or more time segments, each particular TAT time that has not been removed, a TAT outlier baseline and a target TAT.

8. The method of claim 1, wherein creating and storing TAT measurement data comprises:
receiving laboratory performance data comprising timestamps and a plurality of performance data attributes for one or more laboratory sample processing stages in a testing laboratory;
based, at least in part, on the timestamps and the performance data attributes, determining the one or more time segments for the particular event of interest and storing the one or more time segments in the TAT measurement data;
based at least in part on the performance data attributes, generating, for the particular time segment from the one or more time segments, the particular TAT value, and storing the particular TAT value in association with the particular time segment in the TAT measurement data.

9. A non-transitory computer-readable storage medium storing one or more sequences of instructions which, when executed by one or more processors, cause the one or more processors to perform:
creating and storing laboratory test turnaround time (TAT) measurement data comprising one or more TAT values for one or more time segments associated with one or more laboratory sample processing stages in a testing laboratory;
wherein, for a particular laboratory sample processing stage, a particular TAT value, from the one or more TAT values, is associated with a particular time segment, from the one or more time segments;
applying one or more time segment specific rules to the particular TAT value associated with the particular time segment to determine whether the particular TAT value is invalid;
in response to determining that the particular TAT value is invalid, modifying the TAT measurement data for the particular time segment for the particular stage by removing the particular TAT value;
repeating the applying and the modifying for all the TAT measurement data.

10. The non-transitory computer-readable storage medium of claim 9, further storing instructions which, when executed, cause the one or more processors to perform:
determining a type of the particular time segment and storing the type in association with the particular time segment;
wherein the type is any one of: admit-to-order, order-to-collect, order-to-collect, collect-to-receive, receive-to-perform, perform-to-verify, admit-to-receive, receive-to-bench, bench-to-verify, order-to-receive, receive-to-verify, collect-to-verify, order-to-verify, and admit-to-verify;
in response to determining that the type of the particular time segment is the admit-to-order, the collect-to-receive, the receive-to-bench, the receive-to-perform, the admit-to-receive, the order-to-receive, or the collect-to-order, removing the particular TAT value from the TAT measurement data in response to determining that the particular TAT value is non-positive.

11. The non-transitory computer-readable storage medium of claim 10, further storing instructions which, when executed, cause the one or more processors to perform:
in response to determining that the type of the particular time segment is the order-to-collect, determining whether the particular TAT value is associated with an emergency department, and if it is not, removing the particular TAT value if the particular TAT value is negative.

12. The non-transitory computer-readable storage medium of claim 10, further storing instructions which, when executed, cause the one or more processors to perform:
in response to determining that the type of the particular time segment is bench-to-verify, receive-to-verify, admit-to-verify, order to verify, or collect-to-verify, in response to determining that the particular TAT value is either non-positive or exceeds a threshold value, removing the particular TAT value.

13. The non-transitory computer-readable storage medium of claim 10, further storing instructions which, when executed, cause the one or more processors to perform:
in response to determining that the type of the particular time segment is the perform-to-verify, removing the particular TAT value in response to determining that the particular TAT value is either zero but not associated with an auto-validation or negative.

14. The non-transitory computer-readable storage medium of claim 10, further storing instructions which, when executed, cause the one or more processors to perform:
in response to determining that the type of the particular time segment is the receive-to-verify, removing the particular TAT value in response to determining that the particular TAT value is either non-positive or exceeds a threshold value.

15. The non-transitory computer-readable storage medium of claim 10, further storing instructions which, when executed, cause the one or more processors to perform:
based, at least in part, on the TAT measurement data, generating one or more outlier graphical screen displays in a computer display unit that represent the particular laboratory sample processing stage occurring within one or more time intervals, and that depict the one or more time segments, each particular TAT time for each particular time segment from the one or more time segments, each particular TAT time that has not been removed, a TAT outlier baseline and a target TAT.

16. The non-transitory computer-readable storage medium of claim 9, further storing instructions which, when executed, cause the one or more processors to perform:
receiving laboratory performance data comprising timestamps and a plurality of performance data attributes for events of interest;
based, at least in part, on the timestamps and the performance data attributes, determining the one or more time segments for the particular event of interest and storing the one or more time segments in the TAT measurement data;
based at least in part on the performance data attributes, generating, for the particular time segment from the one or more time segments, the particular TAT value, and storing the particular TAT value in association with the particular time segment in the TAT measurement data.

17. A method, comprising:
creating and storing test turnaround time (TAT) measurement data comprising one or more TAT values for one or more time segments associated with one or more laboratory sample processing stages in a testing laboratory;
wherein, for a particular laboratory sample processing stage, a particular TAT value, from the one or more TAT values, is associated with a particular time segment, from the one or more time segments;
in response to determining that the particular time segment is an order-to-collect time segment, removing the particular TAT value from the TAT measurement data in response to determining that the particular TAT value is non-positive and not associated with an emergency department testing;
in response to determining that the particular time segment is an collect-to-receive segment, removing the particular TAT value from the TAT measurement data in response to determining that the particular TAT value is non-positive;
in response to determining that the particular time segment is an receive-to-bench segment, removing the particular TAT value from the TAT measurement data in response to determining that the particular TAT value is non-positive;
in response to determining that the particular time segment is a bench-to-verify segment, removing the particular TAT value from the TAT measurement data in response to determining that the particular TAT value is non-positive or that the particular TAT value is positive but does not exceed a threshold value;
in response to determining that the particular time segment is a perform-to-verify segment, removing the particular TAT value from the TAT measurement data in response to determining that the particular TAT value is negative or that the particular TAT value is zero and associated with an auto-validation;
in response to determining that the particular time segment is a receive-to-verify segment, removing the particular TAT value from the TAT measurement data in response to determining that the particular TAT value is non-positive or that the particular TAT value is positive but does not exceed the threshold value;
repeating the determining for all the TAT measurement data;
wherein the method is performed by one or more computing devices.

18. The method of claim 17, wherein the threshold value is determined based on a subset of the TAT measurement data that is specific to an add-on-testing, and wherein the emergency department testing is performed at an emergency department.

19. The method of claim 17, further comprising:
based, at least in part, on the TAT measurement data, generating one or more outlier graphical screen displays in a computer display unit that represent the particular laboratory sample processing stage occurring within one or more time intervals, and that depict the one or more time segments, each particular TAT time for each particular time segment from the one or more time segments, each particular TAT time that has not been removed, a TAT outlier baseline and a target TAT.

20. The method of claim 17, further comprising:
receiving laboratory performance data comprising timestamps and a plurality of performance data attributes for events of interest;
based, at least in part, on the timestamps and the performance data attributes, determining the one or more time segments for the particular event of interest and storing the one or more time segments in the TAT measurement data;
based at least in part on the performance data attributes, generating, for the particular time segment from the one or more time segments, the particular TAT value, and storing the particular TAT value in association with the particular time segment in the TAT measurement data.
